(19) United States
(12) Patent Application Publication
(10) Pub. No.: US 2018/0283893 A1
(43) Pub. Date: Oct. 4, 2018

(54) INFORMATION ANALYSIS DEVICE AND INFORMATION ANALYSIS METHOD

(71) Applicant: HONDA MOTOR CO., LTD., Tokyo (JP)

(72) Inventors: Tadashi Kurihara, Tokyo (JP); Yoshiaki Sugimoto, Tokyo (JP); Minoru Fukumori, Tokyo (JP); Shunsuke Kawasaki, Tokyo (JP)

(21) Appl. No.: 15/925,973

(22) Filed: Mar. 20, 2018

(30) Foreign Application Priority Data
Mar. 30, 2017 (JP) 2017-068182

(51) Int. Cl. G01C 21/36; G06T 11/60

(52) U.S. Cl. CPC G01C 21/3673; G01C 21/3676; G06T 11/60

(57) ABSTRACT

Analysis information capable of informing an accurate analysis result is generated while individual information is protected. An information analysis device 30 includes a communication unit 33 receiving position information of a plurality of vehicles 60; a storage unit 32 storing map information 321 including a facility position relevant to a facility; and a control unit 31 generating analysis information for displaying the position information of the vehicle 60 visiting to the facility, which is time-discretely changed, to be superimposed on the map information 321 at a predetermined transmissivity.

This application is based on and claims the benefit of priority from Japanese Patent Application No. 2017-068182, filed on 30 Mar. 2017, the content of which is incorporated herein by reference.

### BACKGROUND OF THE INVENTION

### Field of the Invention

The present invention relates to an information analysis device and an information analysis method, for performing information analysis with respect to a movable body visiting to a facility.

### Related Art

In the related art, a technology has been known, in which position information of a movable body such as a vehicle is acquired, and various analyses are performed on the basis of the acquired position information. An example of such a technology, for example, is disclosed in Patent Document 1. In the technology disclosed in Patent Document 1, probe information output by a portable terminal, which is moved along with a movable body, is analyzed, and thus, a movement route of the movable body, and positions of a start point and an end point of the movement route are specified. Then, how the movable body visits to the facility in which kind of route is analyzed from the start point of the movable body or the like visiting to a facility (for example, a station), which is the end point, on the basis of the specified movement route, and the specified positions of the start point and the end point, and an analysis result is displayed. A user referring the analysis result, is capable of recognizing a movement route or the like of each user of the facility (for example, a station), which is the end point.

Patent Document 1: Japanese Unexamined Patent Application, Publication No. 2015-76005

### SUMMARY OF THE INVENTION

In a case of using the technology disclosed in Patent Document 1, as described above, it is possible to display a start point or a movement route of each of the users visiting to the facility. However, in the technology disclosed in Patent Document 1, the movement route or the start point at the time of visiting to the facility is displayed, and thus, individual information such as the position of the own home or the position of the office of a person visiting to the facility, can be assumed. In order to solve such a problem, masking of the specified movement route and the specified start point has been considered. However, it is cumbersome for the user to perform an operation for masking each time. In addition, there is a case where it is difficult for the user to accurately recognize the displayed analysis result according to the degree of masking.

The present invention has been made in consideration of such circumstances, and an object of the present invention is to provide an information analysis device and an information analysis method, generating analysis information capable of informing an accurate analysis result, while protecting individual information.

(1) An information analysis device of the present invention (for example, an information analysis device 30 described below), a receiving unit (for example, a communication unit 33 described below) receiving position information of a plurality of movable bodies (for example, a vehicle 60 described below); a storage unit (for example, a storage unit 32 described below) storing map information (for example, map information 321 described below) including a facility position relevant to a facility; and a control unit (for example, control unit 31 described below) generating analysis information for displaying the position information of the movable body visiting to the facility, which is time-discretely changed, to be superimposed on the map information at a predetermined transmissivity.

According to (1) described above, the position information of the movable body visiting to any one of the plurality of facilities, which is time-discretely changed, is displayed to be superimposed on the map information at the predetermined transmissivity. Accordingly, according to (1) described above, it is difficult for a user to visually confirm each position information item with the naked eye due to the transmission of the position information, and thus, it is possible to protect the individual information. On the other hand, the transmitted position information is superimposed, and thus, it is possible to visually confirm a portion of the overlapping position information with the naked eye. That is, it is possible to generate the analysis information capable of informing an accurate analysis result while protecting the individual information.

(2) In the information analysis device according to (1) described above, the map information may include facility positions relevant to a plurality of facilities, and the control unit may further, receive designation of at least one facility from the plurality of facilities, and generate analysis information for displaying the position information of the movable body visiting to any one of the plurality of designated facilities, which is time-discretely changed, to be superimposed on the map information at the predetermined transmissivity.

According to (2) described above, the designation of the facility is received, and thus, the analysis can be performed according to the designation. Accordingly, it is possible for the user to perform desired analysis.

(3) In the information analysis device according to (1) or (2) described above, time information indicating positioning time of the position information may be incidental to the position information of the movable body, which is received by the receiving unit, and the control unit may further, receive designation of a time zone, and generate analysis information for displaying the position information of the movable body visiting to the facility at the designated time zone, which is time-discretely changed, to be superimposed on the map information at the predetermined transmissivity.

According to (3) described above, the designation of the time zone is received, and thus, the analysis can be performed according to the designation. Accordingly, it is possible for the user to perform the desired analysis.

(4) In the information analysis device according to any one of (1) to (3) described above, the control unit may further,

receive designation of any one of an outward way and an inward way at the time of visiting to the facility, and generate analysis information for displaying any one of the position information of the movable body on the outward way, which is time-discretely changed, and the position information of the movable body on the inward way, which is time-discretely changed, to be superimposed on the map information at the predetermined transmissivity, on the basis of the designation.

According to (4) described above, the designation of the outward way or the inward way is received, and thus, the analysis can be performed according to the designation. Accordingly, it is possible for the user to perform the desired analysis.

(5) In the information analysis device according to (4) described above, the receiving unit may further receive any one or both of activation information and suspension information of the plurality of movable bodies, and the control unit may further, determine the position information received before the suspension information is received, as the position information of the outward way, in a case in which the facility position included in the map information is coincident with a position which is specified by the suspension information, and determine the position information received after the activation information is received, as the position information of the inward way, in a case in which the facility position included in the map information is coincident with a position which is specified by the activation information.

According to (5) described above, it is possible to accurately specify the position information of the outward way or the position information of the inward way, on the basis of the activation information or the suspension information.

(6) An information analysis method of the present invention, which is performed by a computer (for example, the information analysis device 30 described below), includes: a receiving step of receiving position information of a plurality of movable bodies (for example, the vehicle 60 described below); a storing step of storing map information (for example, the map information 321 described below) including a facility position relevant to a facility; and a controlling step of generating analysis information for displaying the position information of the movable body visiting to the facility, which is time-discretely changed, to be superimposed on the map information at a predetermined transmissivity.

According to the method of (6) described above, the same effects as those of the information analysis device according to (1) are obtained.

According to the present invention, it is possible to generate the analysis information capable of informing an accurate analysis result while protecting the individual information.

### BRIEF DESCRIPTION OF THE DRAWINGS

FIG. 1 is a block diagram illustrating a basic configuration of the entire information analysis system, which is an embodiment of the present invention.

FIG. 2 is a functional block diagram illustrating a functional configuration of an onboard navigation device in the embodiment of the present invention.

FIG. 3 is a functional block diagram illustrating a functional configuration of a portable terminal in the embodiment of the present invention.

FIG. 4 is a functional block diagram illustrating a functional configuration of the information analysis device in the embodiment of the present invention.

FIG. 5 is a diagram illustrating an example of a position information database in the embodiment of the present invention.

FIG. 6 is a functional block diagram illustrating a functional configuration of an analysis information reference device in the embodiment of the present invention.

FIG. 7 is a diagram illustrating an example of display of map information for displaying analysis information in the embodiment of the present invention.

FIG. 8 is a diagram illustrating transmission display in the embodiment of the present invention.

FIG. 9 is a diagram illustrating an example of transmission display of position information for displaying the analysis information in the embodiment of the present invention.

FIG. 10 is a diagram illustrating a display example of the analysis information (map information display and the transmission display of the position information) in the embodiment of the present invention.

FIG. 11 is a diagram illustrating admittance with respect to a target facility in the embodiment of the present invention.

FIG. 12 is a flowchart illustrating a basic operation at the time of collecting the position information and of updating the position information database in the embodiment of the present invention.

FIG. 13 is a flowchart illustrating a basic operation at the time of information analysis processing in the embodiment of the present invention.

### DETAILED DESCRIPTION OF THE INVENTION

Hereinafter, a preferred embodiment of an information analysis system of the present invention will be described in detail with reference to the drawings.

<Entire Configuration of Information Analysis System 1>

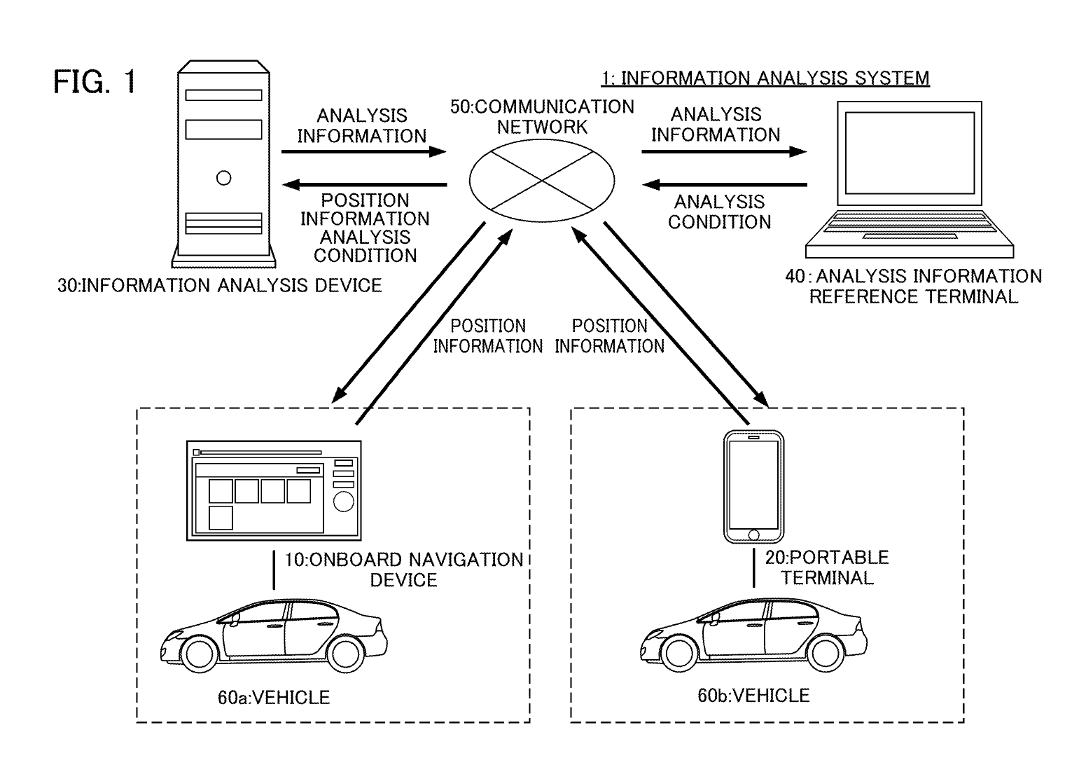

An information analysis system 1 according to a preferred embodiment of the present invention will be described. FIG. 1 illustrates the entire configuration of the information analysis system 1.

As illustrated in FIG. 1, the information analysis system 1 includes an onboard navigation device 10, a portable terminal 20, an information analysis device 30, and an analysis information reference device 40. Each device and each terminal can be connected to communicate with each other through a communication network 50. Furthermore, in the drawing, information to be transmitted and received with respect to each device and each terminal is illustrated, but such information is merely an example. In this embodiment, information other than the illustrated information may be transmitted and received.

The onboard navigation device 10 is a device performing navigation (route guidance) with respect to a user in a vehicle 60a. The onboard navigation device 10 performs the route guidance from a current position to a destination, on the basis of the request of user. In addition, the onboard navigation device 10 also has a function of positioning position information of the onboard navigation device 10 (that is, position information of the vehicle 60a). The position information positioned by the onboard navigation device 10 is suitably transmitted to the information analysis device 30. The onboard navigation device 10 can be realized by a car navigation device fixed to the vehicle 60a, which is a movable body, or a portable navigation device (PND) which is simply disposed on the vehicle 60a, which is the movable body, and can be transported.

The portable terminal 20 is a portable terminal used by the user in a vehicle 60b. As with the onboard navigation device 10 described above, the portable terminal 20 has a function of positioning the position information of the portable terminal 20 (that is, position information of the vehicle 60b). As with the position information positioned by the onboard navigation device 10, the position information positioned by the portable terminal 20 is suitably transmitted to the information analysis device 30. The portable terminal 20 can be realized by a smart phone, a mobile phone, a tablet terminal, a laptop computer, and other portable electronic devices.

Furthermore, in the drawing, one combination between the onboard navigation device 10 and the vehicle 60a, and one combination between the portable terminal 20 and the vehicle 60b are illustrated one by one, but the number of such combinations is not particularly limited. In addition, in the following description, in a case of not distinguishing the vehicle 60a on which the onboard navigation device 10 is mounted, from the vehicle 60b in which the user using the portable terminal 20 exists, the suffix alphabet will be omitted, and the vehicles 60a and 60b will be simply referred to as a “vehicle 60”.

The information analysis device 30 is a device for generating analysis information capable of informing an accurate analysis result while protecting individual information, as unique processing of this embodiment. The information analysis device 30 acquires the position information of each of the vehicles 60 from the onboard navigation device 10 or the portable terminal 20, and thus, prepares a position information database, which is a database with respect to the position information of each of the vehicles 60. In addition, the information analysis device 30 stores map information including facility positions relevant to a plurality of facilities. Then, the information analysis device 30 generates “analysis information” for displaying the position information of the movable body visiting to the facility, which is time-discretely changed, to be superimposed on the map information at a predetermined transmissivity.

According to such analysis information, it is difficult for the user to visually confirm each of the position information items with the naked eye due to the transmission of the position information, and thus, it is possible to protect the individual information. On the other hand, the transmitted position information is superimposed, and thus, it is possible to visually confirm a portion of the overlapping position information with the naked eye. Then, for example, how the user visiting to a certain facility visits the facility through which route, or how the user returns through which route after visiting to the certain facility is grasped on the basis of the analysis information. That is, an outward way before visiting to the facility and an inward way after visiting to the facility are grasped. That is, according to this embodiment, it is possible to generate the analysis information capable of informing an accurate analysis result while protecting the individual information.

The generated analysis information is transmitted from the information analysis device 30 to the analysis information reference device 40, and is displayed on the analysis information reference device 40 with respect to the user. Furthermore, the analysis information is generated to be coincident with the “analysis condition” transmitted by the analysis information reference device 40, on the basis of the input of the user. The details of the analysis information or the analysis condition will be described below. The information analysis device 30, for example, can be realized by a server device.

The analysis information reference device 40 is a terminal which is operated by the user using the analysis information. The user using the analysis information inputs a desired analysis condition with respect to the analysis information reference device 40, in order to obtain the analysis information according to a desired condition. The input analysis condition is transmitted to the information analysis device 30. In this case, as described above, the information analysis device 30 generates the analysis information corresponding to the analysis condition, and sends a reply with respect to the analysis information reference device 40. Then, the analysis information reference device 40 outputs the received analysis information with respect to the user using the analysis information.

Thus, the user of the analysis information reference device 40 is capable of obtaining the analysis information according to the desired condition. Furthermore, the analysis information reference device 40, for example, can be realized by a personal computer.

The communication network 50 is realizes by a network such as the internet or a portable telephone network, and a network such as a combination thereof. In addition, a local area network (LAN) may be included in a part of the network (for example, between the information analysis device 30 and the analysis information reference device 40).

The vehicle 60 is a movable body in which the onboard navigation device 10 or the user of the portable terminal 20 exists. The vehicle 60, for example, is realized by a four-wheel vehicle, a motorcycle, a bicycle, or the like.

<Functional Block of Onboard Navigation Device 10>

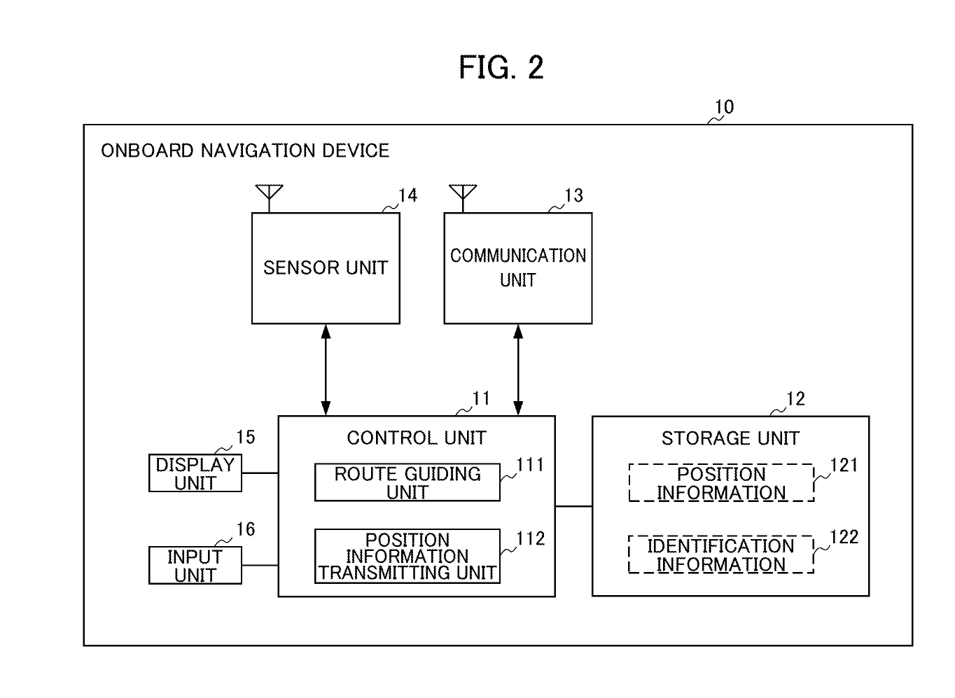

Next, a functional block of the onboard navigation device 10 will be described with reference to a block diagram of FIG. 2. Here, a power source is supplied from the vehicle 60a, and an ignition-switch-on state of the vehicle 60a is set by the user in the vehicle 60a (an engine is activated), and thus, the onboard navigation device 10 is automatically activated. Then, the onboard navigation device 10 is operated until an ignition-switch-off state of the vehicle 60a is set by the user in the vehicle 60a (the engine is suspended).

As illustrated in FIG. 2, the onboard navigation device 10 includes a control unit 11, a storage unit 12, a communication unit 13, a sensor unit 14, a display unit 15, and an input unit 16.

The control unit 11 is configured of an arithmetic processing device such as a microprocessor, and controls each unit configuring the onboard navigation device 10. The details of the control unit 11 will be described below.

The storage unit 12 is configured of a semiconductor memory or the like, and stores each program such as a control program referred to as firmware or an operating system, a program for performing route guidance processing, a program for performing transmission processing of the position information with respect to the information analysis device 30, and various information items such as the map information. In the drawing, position information 121 and identification information 122, which are information particularly relevant to the transmission processing of the position information, are illustrated as the information stored in the storage unit 12.

The position information 121 the position information of the onboard navigation device 10 (that is, the position information of the vehicle 60a) which is positioned by the sensor unit 14 described below. The position information 121 may include not only the information indicating the positioned position, but also time when the positioning is performed. In addition, the identification information 122 is information for identifying the onboard navigation device 10. For example, a production number or the like, which is uniquely assigned to the onboard navigation device 10, can be used as the identification information 122. In addition, in order for the communication unit 13 to be connected to the communication network 50, which is a network such as a portable telephone network, a telephone number applied to a subscriber identity module (SIM) inserted into the communication unit 13 can be used as the identification information 122. In addition, a vehicle identification number (VIN) or a number of a number plate, which is intrinsically applied to the vehicle 60a, can be used as the identification information 122.

Each of the information items stored in the storage unit 12 may be stored in advance in the storage unit 12, or may be suitably download from a server device or the like (not illustrated) connected to the communication network 50, as necessary. Further, the information may be suitably corrected according to the input of the user.

The communication unit 13 includes a digital signal processor (DSP) or the like, and realizes wireless communication with respect to other devices (for example, the information analysis device 30) through the communication network 50, on the basis of a standard such as 3rd generation (3G), long term evolution (LTE), and Wi-Fi (Registered Trademark). The communication unit 13, for example, is used for a position information transmitting unit 112 described below to transmit the position information 121 and the identification information 122 stored in the storage unit 12 to the information analysis device 30. Here, data which is transmitted and received between the communication unit 13 and the other device, is not particularly limited, and information other than the position information 121 and the identification information 122 may be transmitted and received.

The sensor unit 14, for example, is configured of a global positioning system (GPS) sensor, a gyro sensor, an acceleration sensor, and the like. The sensor unit 14 has a function as a position detection unit detecting the position information, receives a GPS satellite signal from a GPS sensor, and positions the position information (a latitude and a longitude) of the onboard navigation device 10. The positioning of the sensor unit 14 is performed at a predetermined time interval (for example, a three-second interval) as described above. The positioned position information is stored in the storage unit 12 as the position information 121. Furthermore, in the sensor unit 14, it is possible to further increase a positioning accuracy of the position information of the onboard navigation device 10 on the basis of an angular rate or an acceleration rate, measured by a gyro sensor and an acceleration sensor. In addition, in a case where GPS communication is difficult to be performed or is not capable of being performed, the sensor unit 14 is also capable of calculating the position information of the onboard navigation device 10 according to base station information acquired from the communication unit 13, by using assisted global positioning system (AGPS) communication.

The display unit 15 is configured of a display device such as a liquid crystal display and an organic electroluminescence panel. The display unit 15 receives an instruction from the control unit 11, and displays an image. The information displayed on the display unit 15, for example, the current position of the onboard navigation device 10, map information in the vicinity of the current position of the onboard navigation device 10, which is read from the map information, a destination set by the user, meeting information notified from the other onboard navigation device 10, route information, various user interfaces, and the like.

The input unit 16 is configured of an input device (not illustrated) such as a touch panel, which is disposed to be superimposed on a display surface of a physical switch referred to as a numeric keypad, or the display unit 15. A signal based on operation input from the input unit 16, such as press of the numeric keypad according to the user, and touch of the touch panel, is output to the control unit 11, and thus, a selection operation of the user, and a scaling operation of a map can be realized.

Furthermore, even though it is not illustrated, a speaker, a microphone, or the like can be provided. The speaker outputs sound with respect to a driver, and the microphone collects sound generated by the driver. Thus, information can be output from the speaker as sound, or various selections or instructions of the driver to whom sound is input through the microphone can be input into the control unit 11 according to a sound recognition technology.

Next, the details of the control unit 11 will be described. The control unit 11 is configured of a microprocessor including a central processing unit (CPU), a random access memory (RAM), a read only memory (ROM), input/output (I/O), and the like. The CPU executes each program read from the ROM or the storage unit 12, reads the information from the RAM, the ROM, and the storage unit 12 when the program is executed, and writes the information with respect to the RAM and the storage unit 12, and thus, performs delivery of the signal with respect to the communication unit 13, the sensor unit 14, the display unit 15, and the input unit 16. Then, hardware and software (a program) cooperate with each other, and thus, the processing of this embodiment is realized.

The control unit 11 includes a route guiding unit 111 and a position information transmitting unit 112, as a functional block.

The route guiding unit 111 is a portion performing route guidance processing up to the destination such as a facility which is input or selected by the user. The route guidance processing up to the destination is identical to the route guidance processing in a general car navigation system. That is, the route guiding unit 111 generates a map up to the destination, on the basis of the map information (not illustrated) stored in the storage unit 12, superimposes the current position of the onboard navigation device 10, which is positioned by the sensor unit 14, the position of the destination, and the route information up to the destination on the map, and displays the information on the display unit 15, and thus, is capable of performing the route guidance. In this case, sound for route guidance may be further output from the speaker (not illustrated). In addition, information of a road congestion situation, weather information, or the like may be acquired through the communication of the communication unit 13, and the acquired information may be used for the route guidance processing. Furthermore, the route guidance processing up to the destination is well known for a person skilled in the art, and thus, the detailed description thereof will be omitted.

The position information transmitting unit 112 is a portion transmitting the position information 121 and the identification information 122, which are stored in the storage unit 12, with respect to the information analysis device 30, through wireless communication using the communication unit 13. The transmission of the position information 121 and the identification information 122 with respect to the information analysis device 30 according to the position information transmitting unit 112 is periodically performed after the ignition-switch-on state of the vehicle 60a is set (the engine is activated) by the user in the vehicle 60a, and the onboard navigation device 10 is automatically activated, until the ignition-switch-off state of the vehicle 60a is set (the engine is suspended). For example, whenever the sensor unit 14 performing the positioning at a predetermined time interval (for example, a three-second interval), the information is transmitted in real time. In addition, a plurality of information items (for example, the position information 121 and the identification information 122, which are updated at a three-second interval for 3 minutes) may be transmitted at one time, instead of performing the transmission with respect to the information analysis device 30 in real time. That is, so-called burst transmission may be performed. The length of the predetermined time interval, the real-time transmission, or the burst transmission can be arbitrarily set according to an environment or the like to which this embodiment is applied. Thus, the real-time transmission or the burst transmission is performed, and thus, the position information transmitting unit 112 transmits the position information 121 for specifying the movement route of the vehicle 60a, which is positioned by the sensor unit 14, and the identification information 122 with respect to the information analysis device 30.

In this case, the ignition-switch-on state is set (the engine is activated), and a position specified by the position information 121 which is positioned immediately after the onboard navigation device 10 is automatically activated can be transmitted to the information analysis device 30, as an initial vehicle position, that is, a departure position. Further, a position specified by the position information 121 which is positioned immediately before the ignition-switch-off state is set (the engine is suspended) can be transmitted to the information analysis device 30, as a final vehicle position, that is, a parking position. In this case, the activation information which is the position information 121 indicating the departure position, or the suspension information which is the position information 121 indicating the parking position may be added to the position information 121, and then, may be transmitted to the information analysis device 30. For example, a flag indicating the activation information may be transmitted as 1, or a flag indicating the suspension information may be transmitted as 1. Furthermore, the position information 121 (that is, the parking position) positioned immediately before the ignition-switch-off state is set (the engine is suspended) may be transmitted when the ignition-switch-on state is set (the engine is activated), and the onboard navigation device 10 is activated again.

In addition, even in a case of performing the burst transmission, in a case where it is determined that the vehicle 60a arrives at the destination (for example, a certain facility) by the route guiding unit 111, the position information transmitting unit 112 may be switched to perform the real-time transmission. Accordingly, the ignition-switch-off state is set (the engine is suspended) after arriving at a certain facility and before transmitting the position information 121 of the parking position, and thus, it is possible to prevent the position information 121 of the destination such as the facility from not being transmitted with respect to the information analysis device 30.

<Functional Block of Portable Terminal 20>

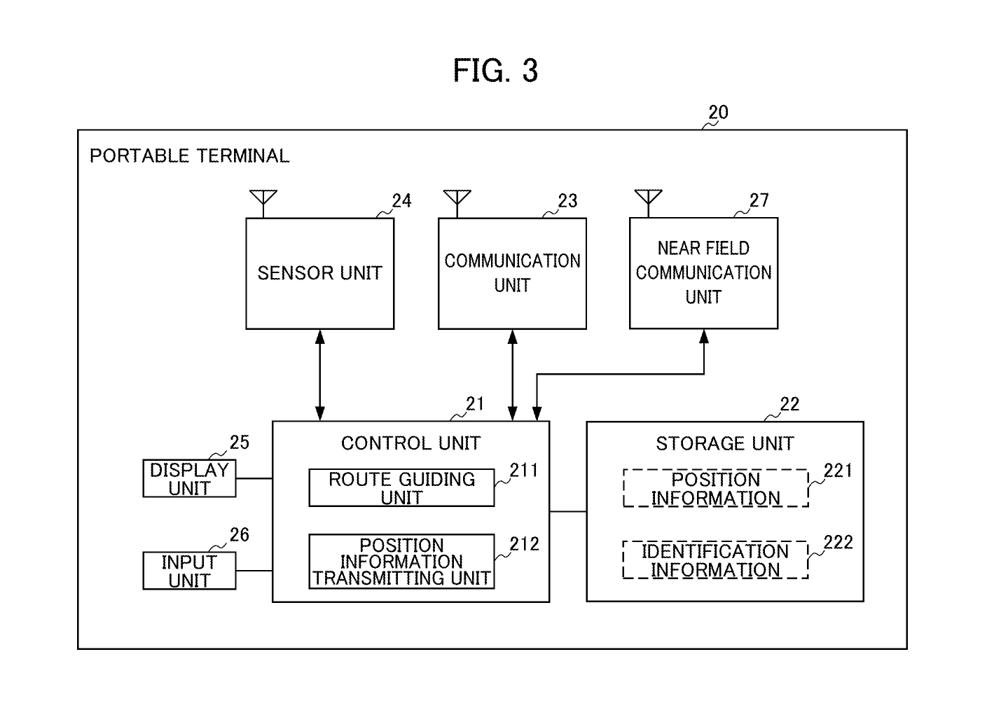

Next, a functional block of the portable terminal 20 will be described with reference to a block diagram of FIG. 3. Here, the onboard navigation device 10 described above receives the supply of the power source from the vehicle 60a, but the portable terminal 20 receives the supply of the power source from a battery (not illustrated) provided therein. Here, in order to charge the battery, the portable terminal 20 may receive the supply of the power source from a cigarette socket or the like of the vehicle 60b.

As illustrated in FIG. 2, the portable terminal 20 includes a control unit 21, a storage unit 22, a communication unit 23, a sensor unit 24, a display unit 25, an input unit 26, and a near field communication unit 27. Here, the control unit 21, the storage unit 22, the communication unit 23, the sensor unit 24, the display unit 25, and the input unit 26 have the same functions as the functional blocks of the same names included in the onboard navigation device 10 described above. That is, each of the functional blocks of the portable terminal 20 will be described by replacing the “onboard navigation device 10” in the description of the onboard navigation device 10 described above with the “portable terminal 20”, and thus, the overlapping description will be omitted.

On the other hand, the portable terminal 20 is different from the onboard navigation device 10 in that the portable terminal 20 includes the near field communication unit 27, and thus, the difference will be described below. The near field communication unit 27 is a portion for performing non-contact near field communication based on a standard such as near field communication (NFC) or Bluetooth (Registered Trademark), or wired near field communication through a universal serial bus (USB) cable or the like. On the other hand, the vehicle 60b includes a near field communication unit for performing communication with respect to the near field communication unit 27. For example, an electronic control unit (ECU) of the vehicle 60b includes the near field communication unit. Then, there is a case where the portable terminal 20 is capable of performing the communication with respect to the ECU through the near field communication, that is, a case where the portable terminal 20 exists in the vehicle 60b. In this case, the position information positioned by the sensor unit 24 of the portable terminal 20 corresponds to the position information of the vehicle 60b.

Therefore, a position information transmitting unit 212 is activated while the portable terminal 20 is capable of performing the near field communication with respect to the ECU through the near field communication unit 27. Then, as with the position information transmitting unit 112 of the onboard navigation device 10, the activated position information transmitting unit 212 transmits position information 221 for specifying the movement route of the vehicle 60b, which is positioned by the sensor unit 24, and identification information 222 with respect to the information analysis device 30.

For example, in a case where the user possessing the portable terminal 20 is in the vehicle 60b, and set an activation switch of the vehicle 60b, such as an ignition switch, to On, the vehicle 60b and the portable terminal 20 are connected to each other (paired with each other), position information 221 positioned by the portable terminal 20, and the identification information 222 are transmitted from the portable terminal 20 to the information analysis device 30. In this case, a position specified by the position information 121 which is positioned immediately after the vehicle 60b and the portable terminal 20 are paired with each other, can be transmitted to the information analysis device 30, as the initial vehicle position, that is, the departure position.

Further, in a case where the activation switch of the vehicle 60b, such as the ignition switch, is set to Off, the pairing between the vehicle 60b and the portable terminal 20 is released. In this case, a position specified by the position information 121 which is positioned immediately before the pairing between the vehicle 60b and the portable terminal 20 is released, can be transmitted to the information analysis device 30, as the final vehicle position, that is, the parking position. In this case, as with the position information transmitting unit 112, the real-time transmission may be performed, or the burst transmission may be performed, the burst transmission may be switched to the real-time transmission in a case where it is determined that the vehicle arrives at the parking position, the activation information or the suspension information, indicating the departure position or the parking position, may be added, and the parking position may be transmitted at the time of performing re-activation.

Furthermore, in a case where the vehicle 60b has a function of positioning the position information, the sensor unit 24 may transmit the position information positioned by the vehicle 60b to the information analysis device 30, as the position information 121 but not the position information to be positioned. In this case, the sensor unit 24 may be omitted from the portable terminal 20.

<Functional Block of Information Analysis Device 30>

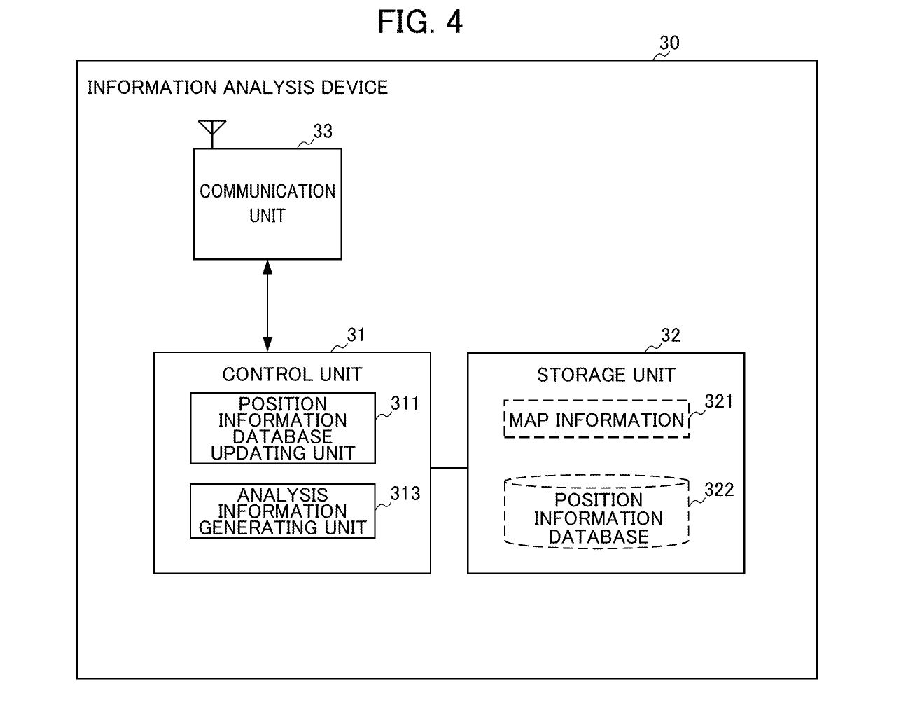

Next, a functional block of the information analysis device 30 will be described with reference to a block diagram of FIG. 4.

As illustrated in FIG. 4, the information analysis device 30 includes a control unit 31, a storage unit 32, and a communication unit 33.

The control unit 31 is configured of an arithmetic processing device such as a microprocessor, and controls each unit configuring the information analysis device 30. The details of the control unit 31 will be described below.

The storage unit 32 is configured of a semiconductor memory or the like, and stores a control program referred to as firmware or an operating system, each program such as a program for performing the information analysis processing, and various information items such as the map information. In the drawing, map information 321 and a position information database 322, which are information particularly relevant to information the analysis processing of the position information, are illustrated as the information stored in the storage unit 32.

The map information 321 includes information relevant to a feature such as a road or a facility, road information, facility position information, and parking lot information. In addition, the map information 321 includes road network data such as map data for displaying a background of a road, a road map, and the like, position information of a node (for example, an intersection, a bending point, a corner point, or the like of the road) and classification information thereof, position information of a link, which is a route connecting the nodes, and classification information thereof, and link cost data relevant to cost information of all of the links (for example, a distance, required time, or the like).

So-called road map information, such as the classification of the road or a traffic light, is stored as the road information. In the facility position information, the position information of each facility is stored as latitude and longitude information. In addition, the facility position information may include incidental information such as identification information (a facility ID), a name, facility classification (and/or genre), a telephone number, an address, and an opening hour of the facility, and in a case where the facility is a restaurant, a menu to be provided, and facility information relevant to merchandise service or the like. In the parking lot information, position information of the parking lot is stored as the latitude and longitude information. In a case where the parking lot is a parking lot of each of the facilities, the facility and the parking lot are stored by being associated with each other.

The map information 321 may be stored in advance in the storage unit 32, or may be suitably downloaded from a server device (not illustrated) or the like which is connected to the communication network 50, as necessary. Further, the map information 321 may be suitably corrected according to the input of the user.

The position information database 322 is a database constructed on the basis of the position information 121 and the position information 221, and the identification information 122 and the identification information 222, which are received from the onboard navigation device 10 and the portable terminal 20, respectively. The position information database 322 is constructed by a position information database updating unit 311 described below. The details of a position information database 322 will be described below when the position information database updating unit 311 is described. Furthermore, in the following description, in a case of not distinguishing the position information 121 from the position information 221, the reference numeral will be omitted, and the position information 121 and the position information 221 will be simply referred to as “position information”. In addition, similarly, in a case of not distinguishing the identification information 122 from the identification information 222, the reference numeral will be omitted, and the identification information 122 and the identification information 222 will be simply referred to as “identification information”.

The communication unit 33 includes a digital signal processor (DSP), and the like, and realizes wireless communication with respect to the other device through the communication network 50, on the basis of a standard such as 3rd generation (3G), long term evolution (LTE), or Wi-Fi (Registered Trademark). The communication unit 33, for example, is used for receiving the position information and the identification information, which are transmitted from the onboard navigation device 10 and the portable terminal 20, respectively. In addition, the communication unit 33, for example, is used for receiving the analysis condition which is transmitted from the analysis information reference device 40. Further, the communication unit 33, for example, is used for transmitting the analysis information with respect to the analysis information reference device 40. Here, the data which is transmitted and received between the communication unit 33 and the other device, is not particularly limited, and information other than the information described above may be transmitted and received.

Next, the details of the control unit 31 will be described. The control unit 31 is configured of a microprocessor including a central processing unit (CPU), a random access memory (RAM), a read only memory (ROM), input/output (I/O), and the like. The CPU executes each program read from the ROM or the storage unit 32, reads the information from the RAM, the ROM, and the storage unit 32 when the program is executed, and writes the information with respect to the RAM and the storage unit 32, and thus, performs delivery of the signal with respect to the communication unit 33, the sensor unit 34, the display unit 35, and the input unit 36. Then, hardware and software (a program) cooperate with each other, and thus, the processing of this embodiment is realized.

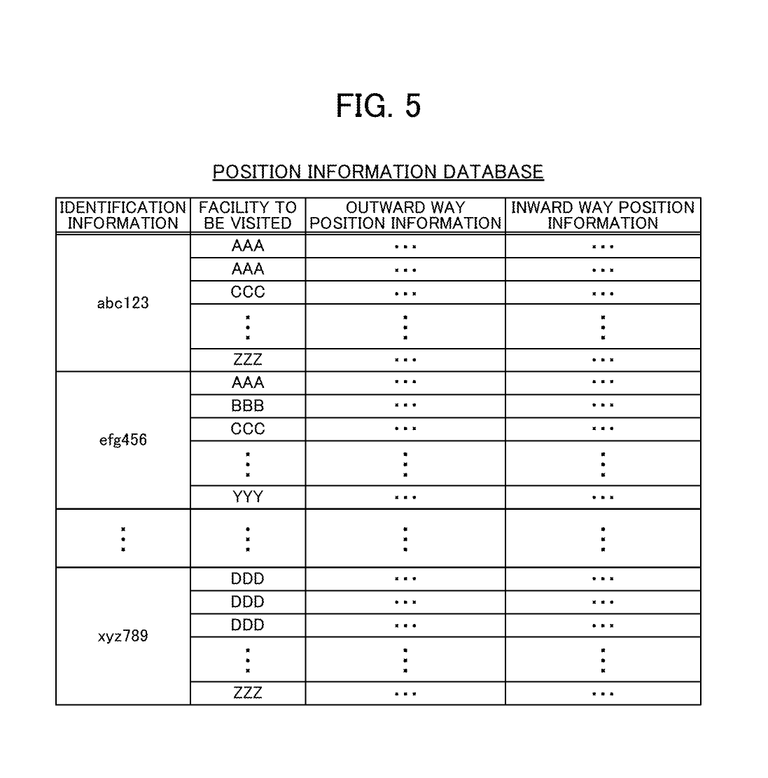

The control unit 31 includes the position information database updating unit 311 and the analysis information generating unit 312, as a functional block. The position information database updating unit 311 is a portion which constructs the position information database 322, and is suitably updated. An example of a data structure of the position information database 322 will be described with reference to FIG. 5.

As illustrated in FIG. 5, the position information database 322 includes the “identification information” which is received from each of the onboard navigation device 10 and the portable terminal 20, as described above. Further, as described above, the position information database 322 includes “facility to be visited”, “outward way position information”, and “inward way position information”, specified by the position information database updating unit 311 on the basis of the “position information” which is received from each of the onboard navigation device 10 and the portable terminal 20, as an attribute. Then, the position information database updating unit 311 stores the information corresponding to each attribute in a field by using the facility to be visited, the outward way position information, and the inward way position information as a combination, for each of the identification information items, and thus, prepares the position information database 322.

Here, the “identification information” in the position information database 322 is information for identifying the onboard navigation device 10 or the portable terminal 20, which is a transmission source of the position information, as described above. That is, the “identification information” is information for identifying the vehicle 60 corresponding to the onboard navigation device 10 or the portable terminal 20.

In addition, the “facility to be visited” in the position information database 322 is information for identifying the facility to which the user visits by the vehicle 60. The position information database updating unit 311 specifies the facility to be visited from the position information received along with the identification information. For example, as described above, a case is considered in which information indicating the parking position is included in the position information. In this case, the parking position is compared to the position of the each of the facilities included in the map information 321 (and the position of the parking lot associated with the facility), and in a case where a specified parking position is coincident with the position of any facility (and the position of the parking lot associated with the facility), it is determined that the user visits to the facility by the vehicle 60.

In this case, the identification information (a facility ID) of the facility included in the map information 321 is stored in the field of the facility to be visited, in the position information database 322. Furthermore, in a case where the information indicating the parking position is not included in the position information, for example, it is possible to consider a position corresponding to the finally received position information as the parking position, from the start to the end of the transmission of the position information. In addition, in a case where a position corresponding to the position information to be transmitted is not changed for longer than or equal to a defined period of time, it is possible to consider the position as the parking position.

Next, the “outward way position information” and the “inward way position information” which are stored in the position information database 322 in this embodiment, will be described. Both of such position information items correspond to the “position information” received from each of the onboard navigation device 10 and the portable terminal 20.

In this embodiment, all of the position information items of the vehicle 60 visiting to any one of the plurality of facilities designated in a searching condition on the outward way at the time of visiting to the facility, which are time-discretely changed, are stored in the position information database 322, as the outward way position information. That is, the outward way position information is information indicating the movement route on the outward way. Similarly, in this embodiment, all of the position information items of the vehicle 60 visiting to any one of the plurality of facilities designated in the searching condition, on the inward way, which is a route from the departure of the vehicle 60 from the facility, after visiting to the facility, which are time-discretely changed, are stored in the position information database 322, as the inward way position information. That is, the outward way position information is information indicating the movement route on the inward way. Then, in this embodiment, the analysis information for displaying the outward way position information or the inward way position information to be superimposed on the map generated from the map information 321 at a predetermined transmissivity.

Next, a method will be described in which the position information database updating unit 311 determines whether the received position information is the outward way position information or the inward way position information. First, in order to determine whether the position information is the outward way position information or the inward way position information, the position information database updating unit 311 specifies a departed position of the user by the vehicle 60, and a parked position, from the position information received along with the identification information.

In the departed position, for example, as described above, in a case where the information indicating the departure position is included in the position information, the departed position is specified according to the information. In addition, in a case where the information indicating the departure position is not included in the position information, for example, it is possible to consider a position corresponding to the initially received position information as the departure position, from the start to the end of the transmission of the position information.

In addition, in the parked position, for example, as described above, in a case where the information indicating the parking position is included in the position information, the parked position is specified according to the information. In addition, in a case where the information indicating the parking position is not included in the position information, for example, it is possible to consider a position corresponding to the finally received position information, or a position which is not changed for a defined period of time, as the parking position, from the start to the end of the transmission of the position information.

Then, the position information database updating unit 311 compares a specified parking position to the position of each of the facilities included in the map information 321 (and the position of the parking lot associated with the facility), and in a case where the specified parking position is coincident with the position of any facility (and the position of the parking lot associated with the facility), the route is determined as the outward way for visiting to the facility. Then, all of the position information items from the departure position to the parking position, which are received before the position information corresponding to the parking position on the outward way is received, and are time-discretely changed, are stored in the position information database 322, as the outward way position information.

In addition, the position information database updating unit 311 compares a specified departure position to the position of each of the facilities included in the map information 321 (and the position of the parking lot associated with the facility), and in a case where the specified departure position is coincident with the position of any facility (and the position of the parking lot associated with the facility), the route is determined as the inward way, which is the route from the vehicle 60 from the facility, after visiting to the facility. Then, all of the position information items from the departure position to the parking position, which are received after the position information corresponding to the departure position on the inward way is received, and are time-discretely changed, are stored in the position information database 322, as the inward way position information.

Furthermore, a “coincidence” degree between the departure position or the parking position and the position of the facility may be arbitrarily set. For example, in a case where the onboard navigation device 10 or the portable terminal 20 is capable of accurately measuring the position information, a range determined as coincidence may be narrow. On the other hand, in a case where the onboard navigation device 10 or the portable terminal 20 is not capable of accurately measuring the position information, the range determined as coincidence may be wide. That is, even in a case where the position is slightly shifted, it may be determined as coincidence.

In addition, the departure position on the outward way and the parking position on the inward way may be in different locations. For example, in a case of visiting to the facility after departing from the own home, and then, returning to the own home, the departure position on the outward way and the parking position on the inward way are in the same location, but in a case of visiting to the facility after departing from the own home, and then, visiting to another facility or the like, the departure position on the outward way and the parking position on the inward way may be in different locations. In this case, the movement route on the outward way, which is specified by the position information on the outward way, and the movement route on the inward way, which is specified by the position information on the inward way, are also different routes. In this embodiment, it is possible to select whether to generate the analysis information with respect to the movement route on the outward way or the movement route on the inward way, on the basis of the analysis condition described below.

Position whenever the transmission of the position information and the identification information is started at one time from any one of the onboard navigation device 10 and the portable terminal 20 and is ended, the position information database updating unit 311 stores each of the information items described above in a new field, on the basis of the received position information and identification information, and thus, updates the position information database 322.

Next, the analysis information generating unit 312 will be described. The analysis information generating unit 312 is a portion preparing the analysis information according to the analysis condition, on the basis of each of the information items stored in the storage unit 32. Here, as described above, the analysis condition is a condition input in order for the user of the analysis information reference device 40 to obtain desired analysis information. The analysis condition input by the user of the analysis information reference device 40 is transmitted to the information analysis device 30, and is acquired by the analysis information generating unit 312.

Here, the analysis condition, for example, includes the designation of the facility to be visited, which is an analysis target. For example, in a case where the user of the analysis information reference device 40 hopes to “set the vehicle 60 visiting to a facility A to the analysis target”, “identification information” of the facility A is input as the analysis condition.

Accordingly, the user of the analysis information reference device 40 is capable of setting a desired facility to the analysis target.

Further, for example, a time zone may be input as another analysis condition. Accordingly, the vehicle 60 visiting to the facility at a certain time zone can be set to the analysis target. For example, in a case where the facility is a restaurant, and the user of the analysis information reference device 40 hopes to “set a so-called lunchtime to the analysis target”, the time zone is designated to be 12:00 to 15:00, as the analysis condition.

Accordingly, the vehicle 60 visiting to the restaurant from 12:00 to 15:00 can be analyzed as a target.

Further, for example, whether to set the outward way position information or the inward way position information to the analysis target may be input as another analysis condition. For example, in a case where the user of the analysis information reference device 40 hopes to “know how the vehicle 60 visiting to the facility is coming from which place through which route”, the outward way position information is designated as the analysis condition.

Accordingly, it is possible to recognize how the vehicle 60 visiting to the facility is coming from which place through which route. In addition, for example, in a case where the user of the analysis information reference device 40 hopes to “know how the vehicle 60 visiting to the facility is going to which place through which route”, the inward way position information is designated as the analysis condition. Accordingly, it is possible to recognize how the vehicle 60 visiting to the facility is going to which place through which route. Furthermore, the analysis conditions described above may be arbitrarily combined with each other.

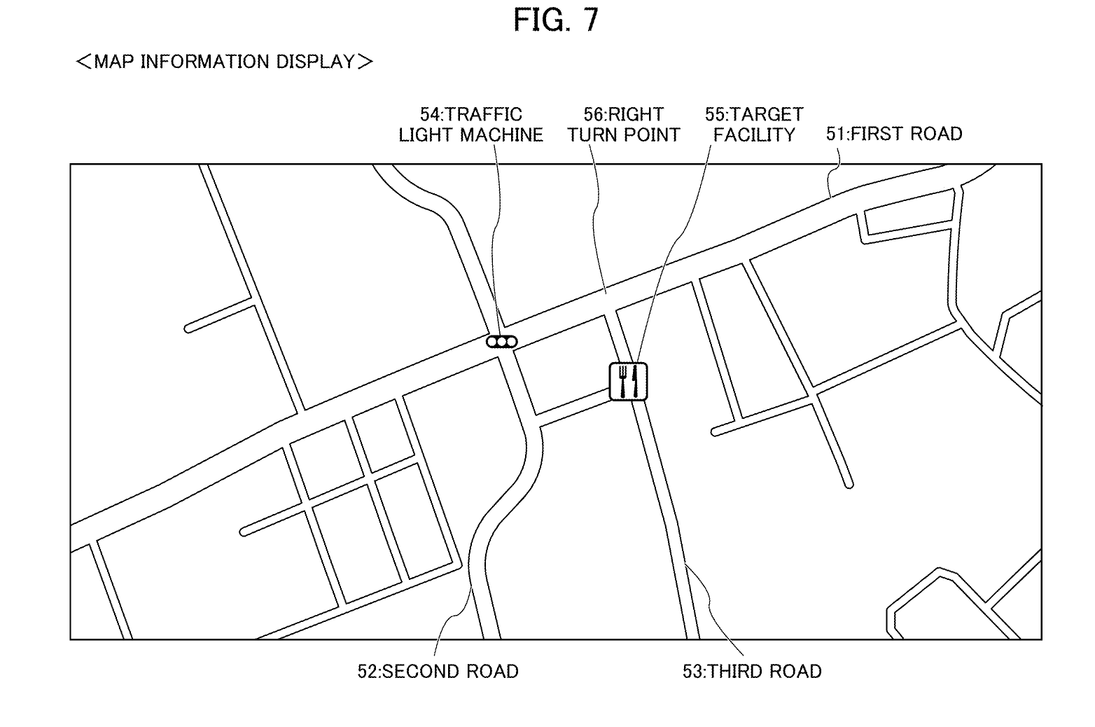

The analysis information generating unit 312 acquires information corresponding to such analysis conditions from the position information database 322, performs analysis on the basis of the position information, and generates the analysis information for displaying an analysis result. The analysis information, for example, is generated as image data for displaying an image with respect to the user. A specific example in a case of displaying the analysis information will be described below with reference to FIG. 7 to FIG. 10, after the analysis information reference device 40 is described.

<Functional Block of Analysis Information Reference Device 40>

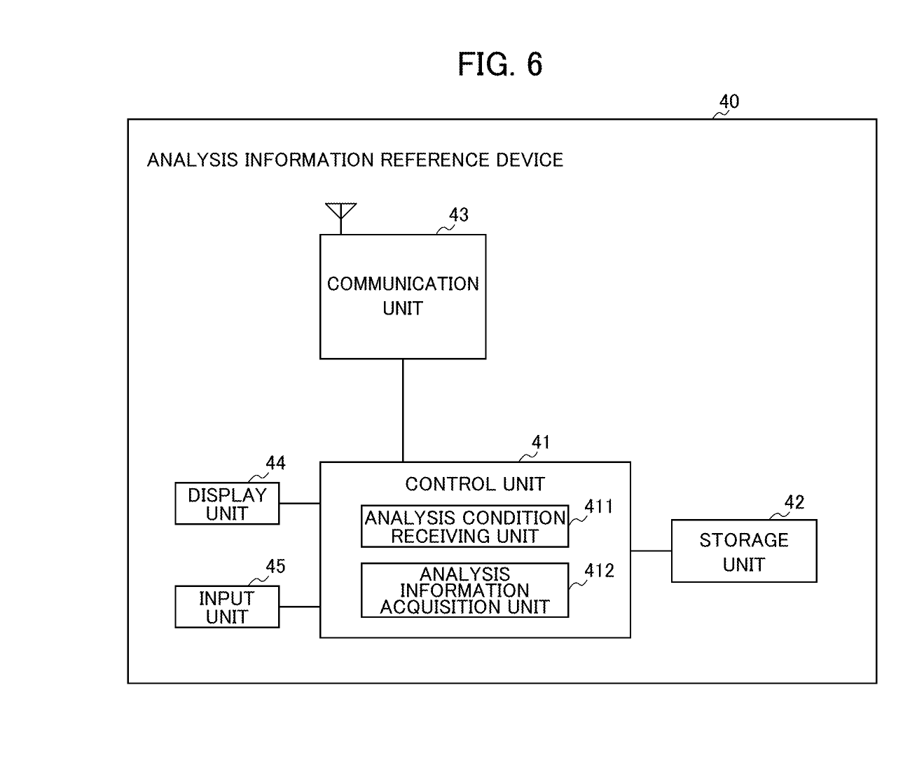

The analysis information reference device 40 can be realized by a general personal computer, and thus, the detailed description thereof will be omitted. As illustrated in FIG. 6, the customer terminal 4 includes at least a control unit 41, a storage unit 42, a communication unit 43, a display unit 44, and an input unit 45. The configuration of each unit, for example, is identical to that of each unit having the same name, of the onboard navigation device 10 or the portable terminal 20.

The control unit 41 includes an analysis condition receiving unit 411 and an analysis information acquisition unit 412. The analysis condition receiving unit 411 generates a user interface for receiving the input of the analysis condition from the user, and displays the generated user interface with respect to the display unit 44 which is realized by a display. The user of the analysis information reference device 40 inputs the analysis condition in the input unit 45 which is input by an input interface such as a keyboard or a mouse, with reference to the user interface. The communication unit 43 transmits the analysis condition with respect to the information analysis device 30, and receives the analysis information from the information analysis device 30. The received analysis information is acquired by the analysis information acquisition unit 412. The analysis information acquisition unit 412 displays the acquired analysis information with respect to the display unit 44. Accordingly, the user of the analysis information reference device 40 is capable of referring to various contents such as an image or a diagram corresponding to the analysis information.

<Specific Example of Display Corresponding to Analysis Information>

Next, a specific example of display corresponding to the analysis information will be described with reference to FIG. 7 to FIG. 10. In this example, the user of the analysis information reference device 40 hopes to know “the movement route of each of the vehicles 60 on the outward way to a target facility 55”. For this reason, “identification information of the target facility 55” is input in the analysis condition, and “outward way position information selection” is designated as the analysis target. The analysis information generating unit 312 searches the position information database 322 by using the identification information of the target facility 55, which is designated by the analysis condition, as a searching key, and extracts the outward way position information of the vehicle 60 visiting to the target facility 55. In addition, the map information 321 in the vicinity of the target facility 55 which is designated by the analysis condition, is acquired. First, a map in the vicinity of a facility, which is a current analysis target, is displayed on the basis of the map information 321, as a premise. A display example of the map is illustrated in FIG. 7.

In the example of FIG. 7, an icon indicating the target facility (a store) 55, a first road 51, a second road 52, and a third road 53, which are three roads to the target facility 55, an icon of a traffic light machine 54 provided in the vicinity of the target facility 55 on the first road 51, and a right turn point 56 which is a point where the vehicle 60, which is on the first road 51, and travels from a left lower direction to a right upper direction in the drawing, turns right at the time of visiting to the target facility 55, are illustrated.

Then, the analysis information generating unit 312 generates analysis information for displaying the outward way position information of the vehicle 60 visiting to the target facility 55 to be superimposed on the map information illustrated in FIG. 7 at a predetermined transmissivity. Here, the predetermined transmissivity of this embodiment will be described.

In this embodiment, the position information coincident with the analysis condition is displayed by being transmitted. This is because in a case where all of the position information items of the vehicle 60 of a certain person, which are time-discretely changed, are displayed without being transmitted, there is a possibility that individual information such as the position of the own home or the office of the person can be assumed. Even in a case where the individual information is not displayed by being associated with the position information, and it is known that the individual information is the position information in which the own home of the certain person is set to the departure position, as a result thereof, it is obvious that the person visits to the facility. Thus, it is not preferable that the individual information can be assumed.

Therefore, in this embodiment, the position information is displayed by being transmitted to the extent that the position information of the certain person is not capable of being easily visually confirmed with the naked eye, and thus, the individual information is protected. In addition, in a case where a plurality of people use the same route even in a case of transmitting the position information, colors to be transmitted are superimposed, and thus, the colors becomes denser, and where the route used by the plurality of people is, can be visually confirmed. In addition, it is also possible to recognize the extent that a large number of persons use the route at a color contrasting density. That is, the position information is transmitted, and thus, it is possible to inform an accurate analysis result while protecting the individual information. For such a reason, in this embodiment, the position information is displayed by being transmitted.

The analysis information generating unit 312 adds A (alpha channel), which is information designating transmissivity, in addition to a plurality of types of color information items such as red, green, and blue (RGB) or cyan, magenta, yellow, and key (CMYK), at the time of generating the analysis information, and indicates the position information, as such a method. There is no designation of the transmissivity in RGB or CMYK, and in general, RGB or CMYK is opacity. That is, RGB or CMYK is not capable of being seen through the back. In contrast, A indicating transmissivity (accurately, opacity) is added, and the value of A (an alpha value) is designated, and thus, the position information is capable of being displayed by being transmitted. In this embodiment, the analysis information generating unit 312 generates the analysis information by using the alpha value as a predetermined value, and thus, the position information is displayed by being transmitted. Furthermore, in the above description, the word of “transmission” or “transmissivity” is used, but there is a case where a word of “transparence” or “transparency” is used as a term.

In addition, in this embodiment, map matching may be performed between the road information included in the map information 321 and the position information at the time of generating the analysis information, but the map matching may not be performed. Here, the onboard navigation device 10 or the portable terminal 20 acquires the position information by a GPS or the like, as described above. In this case, even though there is a difference in an accurately due to the performance of a GPS module, a communication situation of a GPS satellite, or the like, a measurement error slightly occurs. However, the map matching is performed, and thus, the measurement error of each of the vehicles 60 can be absorbed, and the position information can be displayed as one line indicating a travelling route (a flow line).

On the other hand, the map matching is not performed, and thus, the measurement error of each of the vehicles 60 is left as it is. Then, in the vehicle 60 travelling on the same road, a slight shift occurs in a movement position. Accordingly, the shifted position information is superimposed as the number of vehicles 60 travelling on the same road increases, and thus, the line indicating the travelling route (the flow line) becomes thick. Accordingly, it is possible to recognize whether the number of vehicles 60 using the road is large or small.

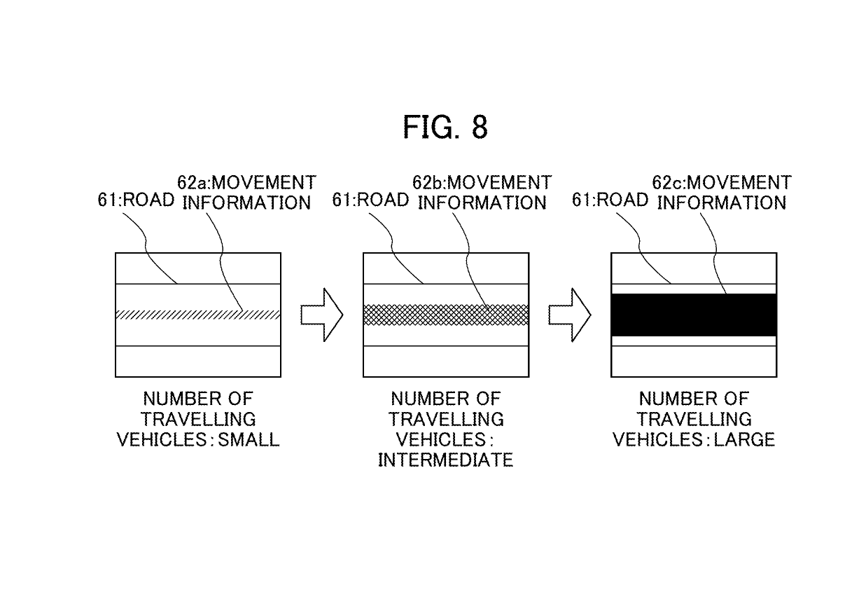

An example of the display of position information in which the map matching using such a predetermined transmissivity is not performed, is illustrated in FIG. 8. Specifically, FIG. 8 illustrates three examples of a case where the road based on the road information included in the map information 321, and the position information of the vehicle 60 travelling on the road are displayed. From the left, an example of position information 63a in a case where the number of travelling vehicles is small, an example of position information 63b in a case where the number of travelling vehicles is moderate, and an example of position information 63c in a case where the number of travelling vehicles is large, are provided. Thus, it is known that even in a case where the position information is superimposed on the same road 61, the line indicating the travelling route (the flow line) based on the position information 62 becomes dense and thick as the number of travelling vehicles increases. According to this, it is possible to accurately recognize an analysis result along with whether the number of people using the road is large or small.

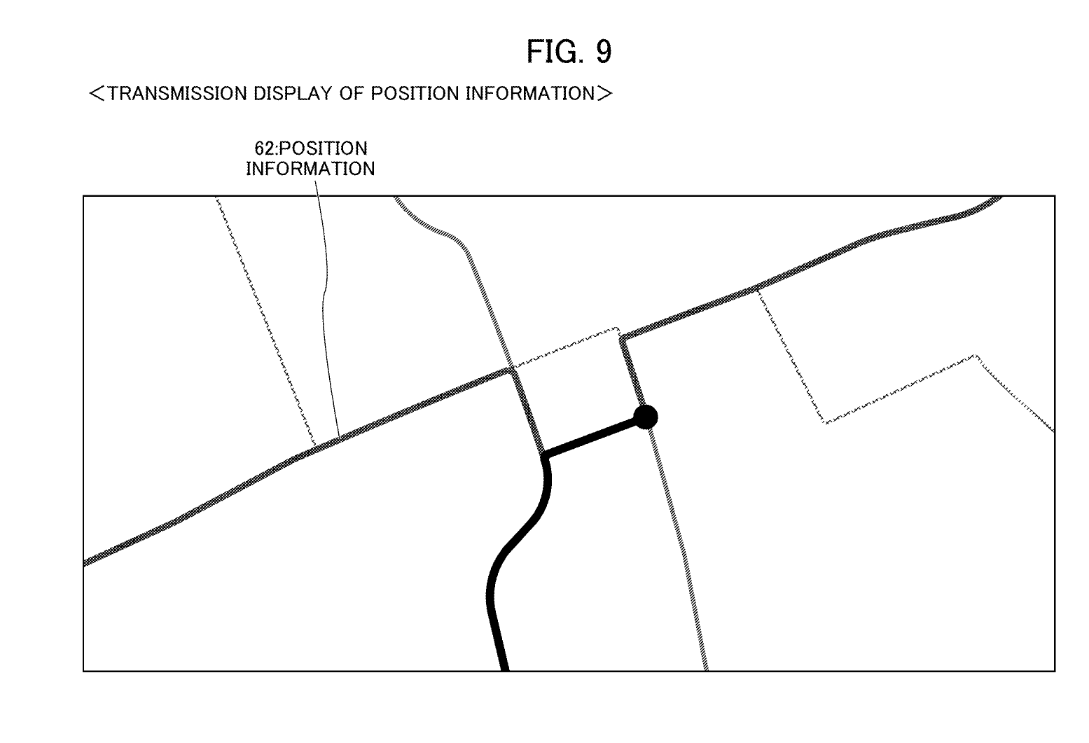

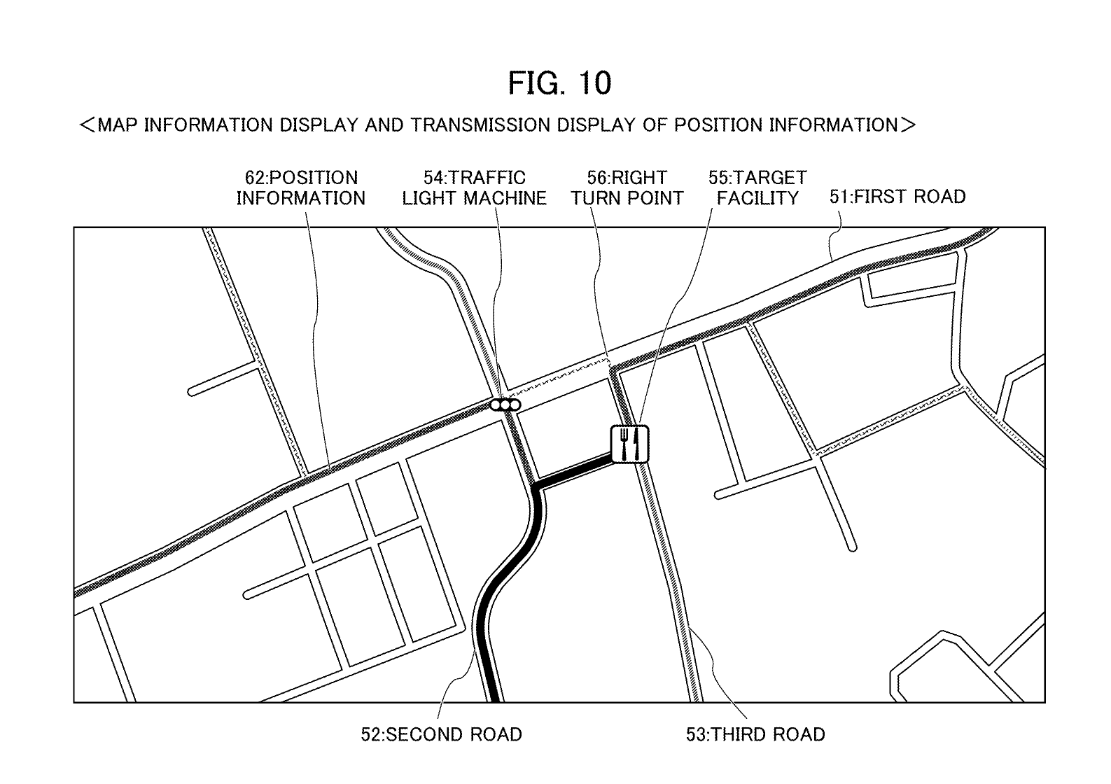

Furthermore, in the attached drawings herein, it is difficult to reproduce the display at the predetermined transmissivity, and thus, in FIG. 8, or FIG. 9 or FIG. 10 described below, the position information 62 is not expressed at a predetermined transmissivity, but is expressed by hatching. In addition, the display at the predetermined transmissivity according to the alpha value described above is an example, and the display at the predetermined transmissivity may be performed by other methods. For example, in a case where the position information 62 is expressed by “n pixels×m pixels (n and m are arbitrary integers)”, all pixels of n pixels×m pixels do not display the position information 62, and for example, the position information 62 may be displayed at intervals of several pixels. According to this, the display of the back is seen at intervals of several pixels, and thus, display equivalent to transmission can be performed.

Then, an example of a case where only the position information based on the analysis condition described above is displayed, is illustrated in FIG. 9. It is known that the position information is displayed on the entire screen at the predetermined transmissivity and a different thickness, with reference to the drawing. Then, the analysis information generating unit 312 generates analysis information for displaying the outward way position information of the vehicle 60 visiting to the target facility 55 to be superimposed on the map information as illustrated in FIG. 7, at the predetermined transmissivity illustrated in FIG. 9. Thus, image data corresponding to the generated analysis information is displayed on the display unit 44, for example, the image data is displayed as illustrated in FIG. 10.

<Usage Example of Display Corresponding to Analysis Information According to User>

According to the display as illustrated in FIG. 10, it is possible for the user referring to the display to recognize an accurate analysis result while protecting the individual information. Accordingly, the user, for example, is capable of performing the following assumption or the like.

For example, the first road 51 in the vicinity of the target facility 55 is a road on which the number of travelling lanes is large, and is illustrated to be thick in the drawing. For this reason, a traffic amount of the first road 51 is large. Here, in a case where the movement position of the vehicle 60 visiting to the target facility 55 on the basis of the searching condition is displayed, in the vehicle 60 travelling on a left lane of the first road 51 from a left lower direction towards a right upper direction in the drawing, it is known that the number of vehicles 60 visiting to the target facility 55 through the second road 52 by turning right at the traffic light machine 54 is greater than the number of vehicles 60 visiting to the target facility 55 by turning right at the right turn point 56. It is possible to assume that the turning right at the traffic light machine 54 is easier than the turning right at right turn point 56. In such a case, it is known that a signboard of the target facility 55 may be provided in front of the traffic light machine 54 (that is, in the drawing, a left lower side of the traffic light machine 54). In contrast, in the vehicle 60 travelling on the left lane of the first road 51 from the right upper direction towards the left lower direction in the drawing, it is known that the vehicle 60 visits to the target facility 55 by turning left at a point of a lane opposite to the right turn point 56. For this reason, it is possible to assume that in a case where a signboard is provided every left turn point, an effect of attracting guests is obtained.

In addition, it is known that the number of vehicles 60 visiting to the target facility 55 using the second road 52 as a route is greater than the number of vehicles 60 visiting to the target facility 55 by using the first road 51 or the third road 53 as a route. Accordingly, for example, it is possible to assume that the number of users who lives in the vicinity of the second road 52 and visits to the target facility 55 by the vehicle 60, is large. That is, it is possible to assume a trading zone of the target facility 55. Accordingly, for example, it is possible to assume that it is effective to distribute a flier or coupon with respect to the trading zone. In addition, for example, in a case where a signboard is newly provided with respect to the target facility 55, there is no trading zone where the existence of the target facility 55 is known in advance, and for example, it is possible to assume that the effect of attracting guests is obtained in a case where the signboard is provided along the first road 51.

In addition, the position information 62 to be displayed is different according to different searching conditions. Then, it is possible to recognize various information items by comparing such different position information items 62. For example, in a time zone of daytime and a time zone of night-time, it is known that the route used at the time of visiting to the target facility 55 is different, and thus, it is known that providing an illumination signboard for night-time in which place is effective, or the trading zone is different in the time zone of daytime and the time zone of night-time.

Furthermore, the display as described above is merely an example, and only the position information 62 may be displayed, or the color of the like of the position information 62 coincident with different conditions may be displayed on the same screen by changing the color.

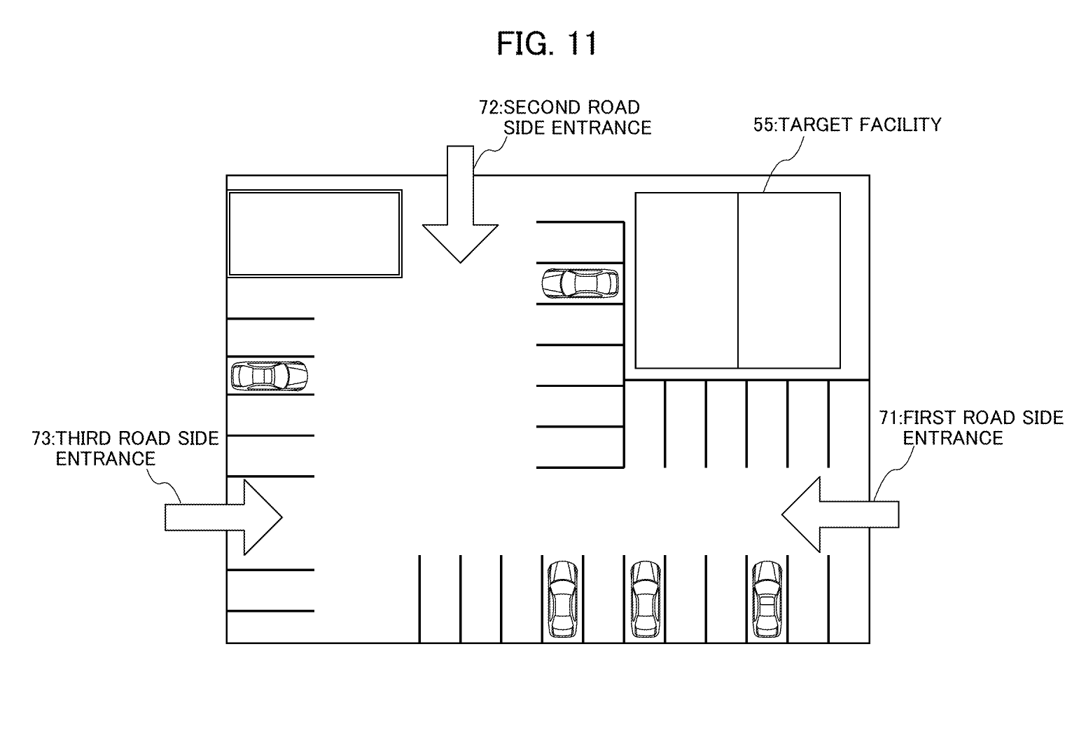

Next, FIG. 11 is a plane view illustrating the parking lot of the target facility 55. In the drawing, the target facility 55, a first road side entrance 71, which is an entrance on the first road 51 side, a second road side entrance 72, which is an entrance on the second road 52 side, and a third road side entrance 73, which is an entrance on the third road 53 side, are illustrated. As described above, according to an analysis result, the number of vehicles 60 visiting to the target facility 55 by turning right in the middle of the second road 52 is greater than the number of vehicles 60 visiting to the target facility 55 by using the first road 51 as a route number of vehicles 60 visiting to the target facility 55 by turning right in the middle of the second road 52. That is, the number of vehicles 60 entering from the second road side entrance 72 is greater than the number of vehicles 60 entering from the first road side entrance 71.

Therefore, it is known that the user may change the layout of the parking lot based on the analysis result such that the vehicle 60 entering from the second road side entrance 72 is easily parked. In addition, in order to increase the number of vehicles 60 entering from the first road side entrance 71, for example, it is known that the first road side entrance 71 widens such that the movement is easily performed, or a guide may be provided.

<Operation of This Embodiment>

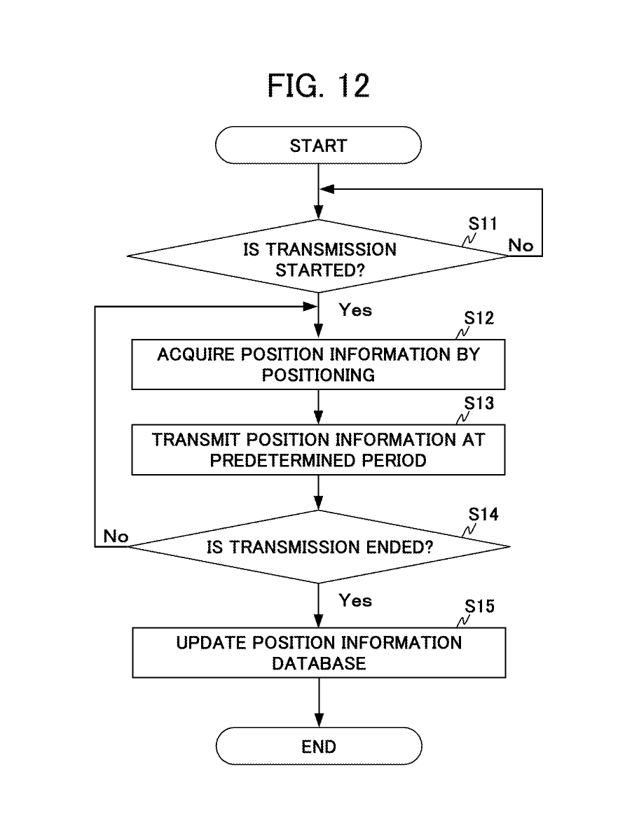

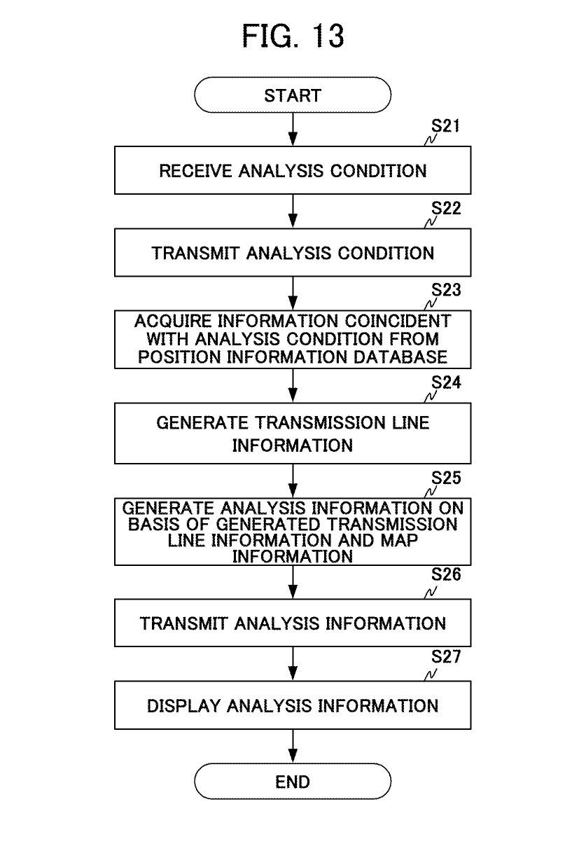

Next, an operation of this embodiment will be described, with reference to flowcharts of FIG. 12 and FIG. 13. Here, FIG. 12 is a flowchart illustrating an operation at the time of collecting the position information and of updating the position information database 322. In addition, FIG. 13 is a flowchart illustrating an operation at the time of information analysis processing.

First, the operation at the time of collecting the position information with respect to the onboard navigation device 10 and of updating the position information database 322 will be described with reference to FIG. 12. The position information transmitting unit 112 determines whether or not the transmission of the position information is started (Step S11). Here, as described above, in a case where the vehicle 60a is in the ignition-switch-on state, the transmission is started. In a case of the ignition-switch-off state (No in Step S11), the transmission according to position information transmitting unit 112 is not started. On the other hand, in a case of the ignition-switch-on state (Yes in Step S11), the process proceeds to Step S12.

In Step S12, the sensor unit 14 acquires the position information by positioning the onboard navigation device 10 (Step S12). The position information transmitting unit 112 acquires the position information from the sensor unit 14, and performs the real-time transmission or the burst transmission of the acquired position information with respect to the information analysis device 30 at a predetermined period (Step S13).

Next, the position information transmitting unit 112 determines whether or not the transmission of the position information is ended (Step S14). As described above, in a case where the vehicle 60a is in the ignition-switch-off state, the transmission is ended. In a case where the vehicle 60a is in the ignition-switch-on state (No in Step S14), the positioning in Step S12 and the transmission in Step S13 are repeated.

On the other hand, in a case where the vehicle 60a is in the ignition-switch-off state (Yes in Step S14), the process proceeds to Step S15.

In Step S15, the position information database updating unit 311 of the information analysis device 30 updates the position information database 322 on the basis of the position information which is transmitted by repeating Step S12 and Step S13 (Step S15). According to the operation described above, the collection of the position information and the update of the position information database are realized.

Next, the operation at the time of collecting the position information with respect to the portable terminal 20 and of updating the position information database will be described. In the portable terminal 20, as described above, the position information transmitting unit 112 may be replaced with the position information transmitting unit 212, the sensor unit 14 may be replaced with the sensor unit 24, the standard to be Yes in Step S11 may be replaced with a “case where the activation switch of the vehicle 60b, such as the ignition switch, is set to On, and the vehicle 60b and the portable terminal 20 are paired with each other”, and the standard to be Yes in Step S14 may be replaced with a “case where the activation switch of the vehicle 60b, such as the ignition switch, is set to Off, and the pairing between the vehicle 60b and the portable terminal 20 is released”. Accordingly, the description of the overlapping will be omitted.

Next, the operation at the time of generating the analysis information will be described, with reference to the flowchart of FIG. 13. First, the analysis condition receiving unit 411 of the analysis information reference device 40 receives the analysis condition from the user through the input unit 45 (Step S21).

Then, the analysis condition receiving unit 411 transmits the received analysis condition with respect to the information analysis device 30 (Step S22).

The analysis information generating unit 312 of the information analysis device 30 receiving the analysis condition acquires the information based on the analysis condition from the position information database 322 (Step S23). For example, the outward way position information or the inward way position information with respect to the facility designated according to the analysis condition is acquired. In a case where there is the designation of the time zone or the like, only the information corresponding to the designation is further acquired.

Next, the analysis information generating unit 312 generates analysis information on the basis of the map information 321, of the information acquired from the position information database 322 in Step S23 (Step S24).

Further, the analysis information generating unit 312 transmits the generated analysis information with respect to the information analysis device 30 (the target facility 55 in Step S2).

The analysis information acquisition unit 412 of the analysis information reference device 40 receiving the analysis information displays the acquired analysis information with respect to the display unit 44 (Step S26). Accordingly, for example, the display is performed as described with reference to FIG. 10.

According to this embodiment described above, it is possible to generate analysis information capable of informing an accurate analysis result while protecting the individual information.

<Advantages of Analysis Information>

Then, it is possible to use the analysis information obtained as described above as information advantageous for the user. For example, it is possible to use the information advantageous to the user as described above in <Usage Example of Display Corresponding to Analysis Information According to User>.

Further, various analysis information items are acquired according to various analysis conditions, and thus, it is possible to perform verification by comparing various analysis information items. For example, the analysis information is acquired with respect to each of the vehicle 60 visiting to the facility in a certain time zone or the like, and the vehicle 60 visiting to the facility in the other time zone, and thus, it is possible to perform verification by comparing different tendencies.

Thus, according to this embodiment, it is possible to provide information advantageous to the user. Furthermore, the analysis information, for example, is advantageous even in a case of being used by an organizer of the facility, or is advantageous in a case of being used by a consultant of the facility. For example, in addition to the consultant with respect to the same brand, it is possible for a content provider to perform consultancy by comparing trading zones of stores of a plurality of brands through the content provider.

<Hardware and Software>

Furthermore, each device included in the navigation system described above can be realized by hardware, software, or a combination thereof. In addition, a navigation method performed by a cooperation between the devices included in the navigation system described above, can be realized by hardware, software, or a combination thereof. Here, the navigation method being realized by software indicates that a computer reads and executes a program, and thus, the navigation method is realized.

The program can be stored by using various types of a non-transitory computer readable medium, and can be supplied to the computer. The non-transitory computer readable medium includes various types of tangible storage media. Examples of the non-transitory computer readable medium include a magnetic storage medium (for example, a flexible disk, a magnetic tape, and a hard disk drive), a magnetooptical storage medium (for example, a magnetooptical disk), CD-read only memory (ROM), CD-R, CD-R/W, and a semiconductor memory (for example, a mask ROM, a programmable ROM (PROM), an erasable PROM (EPROM), a flash ROM, and a random access memory (RAM)). In addition, the program may be supplied to the computer by various types of transitory computer readable media. Examples of the transitory computer readable medium include an electric signal, an optical signal, and an electromagnetic wave. The transitory computer readable medium is capable of supplying the program to the computer through wired communication path such as an electric wire and an optical fiber, or a wireless communication path.

### MODIFICATION EXAMPLE

The embodiment described above is a preferred embodiment of the present invention, but the scope of the present invention is not limited to the embodiment described above, and is capable of including embodiments in which various changes are performed within a range not departing from the scope of the present invention.

For example, the functional configurations of FIG. 2, FIG. 3, FIG. 4, and FIG. 6 are merely an example, and are not limited to the functional configurations of this embodiment. That is, it is sufficient that each device has a function capable of executing a set of processing relevant to an information analysis function of the present invention as a whole, and using which functional block in order to realize the function is not particularly limited to the examples of FIG. 2, FIG. 3, FIG. 4, and FIG. 6.

In addition, as another modification example, the onboard navigation device 10 or the portable terminal 20 may be realized by other devices not having a route guidance function. That is, the route guidance function of the onboard navigation device 10 or the portable terminal 20 is not a required component. In this case, the information analysis device 30 may further have the route guidance function, and the information analysis device 30 may communicate with the onboard navigation device 10 or the portable terminal 20, and thus, the route guidance may be performed.

Further, as another modification example, in the embodiment described above, it has been described that the information analysis device 30 is realized by one server device or the like, but a dispersion processing system may be used in which the functions of the information analysis device 30 are suitably dispersed to a plurality of server devices. In addition, a virtual server function or the like is used on the cloud, and thus, each of the functions of the information analysis device 30 may be realized.

Further, as another modification example, the information analysis device 30 may have a function as the analysis information reference device 40. That is, an input unit and a display unit may be provided in the information analysis device 30, the analysis condition from the user may be received by the input unit of the information analysis device 30, and the analysis information may be displayed on the display unit of the information analysis device 30. In addition, the functions of the analysis information reference device 40 can be divided into an analysis condition input device and an analysis condition reference device. The information analysis device 30 is capable of having one of the divided functions.

### EXPLANATION OF REFERENCE NUMERALS

1 information analysis system
10 onboard navigation device
11, 21, 31, 41 control unit
111, 211 route guiding unit
112, 212 position information transmitting unit
12, 22, 32, 42 storage unit
121, 221 position information
122, 222 identification information
13, 23, 33, 43 communication unit
14, 24 sensor unit
15, 25, 44 display unit
16, 26, 45 input unit
20 portable terminal
27 near field communication unit
30 information analysis device
311 position information database updating unit
312 analysis information generating unit
321 map information
322 position information database
40 analysis information reference device
411 analysis condition receiving unit
412 analysis information acquisition unit
50 communication network
60a, 60b vehicle

What is claimed is:

1. An information analysis device, comprising:
a receiving unit receiving position information of a plurality of movable bodies;
a storage unit storing map information including a facility position relevant to a facility; and
a control unit generating analysis information for displaying the position information of the movable body visiting to the facility, which is time-discretely changed, to be superimposed on the map information at a predetermined transmissivity.

2. The information analysis device according to claim 1,
wherein the map information includes facility positions relevant to a plurality of facilities, and
the control unit further, receives designation of at least one facility from the plurality of facilities, and generates analysis information for displaying the position information of the movable body visiting to any one of the plurality of designated facilities, which is time-discretely changed, to be superimposed on the map information at the predetermined transmissivity.

3. The information analysis device according to claim 1,
wherein time information indicating positioning time of the position information is incidental to the position information of the movable body, which is received by the receiving unit, and
the control unit further, receives designation of a time zone, and generates analysis information for displaying the position information of the movable body visiting to the facility at the designated time zone, which is time-discretely changed, to be superimposed on the map information at the predetermined transmissivity.

4. The information analysis device according to claim 1, wherein the control unit further,
receives designation of any one of an outward way and an inward way at the time of visiting to the facility, and
generates analysis information for displaying any one of the position information of the movable body on the outward way, which is time-discretely changed, and the position information of the movable body on the inward way, which is time-discretely changed, to be superimposed on the map information at the predetermined transmissivity, on the basis of the designation.

5. The information analysis device according to claim 4,
wherein the receiving unit further receives any one or both of activation information and suspension information of the plurality of movable bodies, and
the control unit further,
determines the position information received before the suspension information is received, as the position information of the outward way, in a case in which the facility position included in the map information is coincident with a position which is specified by the suspension information, and
determines the position information received after the activation information is received, as the position information of the inward way, in a case in which the facility position included in the map information is coincident with a position which is specified by the activation information.

6. An information analysis method performed by a computer, the method comprising:
a receiving step of receiving position information of a plurality of movable bodies;
a storing step of storing map information including a facility position relevant to a facility;
a controlling step of generating analysis information for displaying the position information of the movable body visiting to the facility, which is time-discretely changed, to be superimposed on the map information at a predetermined transmissivity.
